(19) United States
(12) Patent Application Publication
(10) Pub. No.: US 2012/0214333 A1
(43) Pub. Date: Aug. 23, 2012

(54) EXTENSION CORD CONVERTER

(76) Inventor: GERRY A. BLODGETT, WORCESTER, MA (US)

(21) Appl. No.: 13/397,538

(22) Filed: Feb. 15, 2012

Related U.S. Application Data
(60) Provisional application No. 61/444,758, filed on Feb. 20, 2011.

(51) Int. Cl. H01R 11/00

(52) U.S. Cl. 439/504

(57) ABSTRACT

A system that converts a standard 110 volt extension cord for use in the extension of the 12 volt vehicle battery power. A first portion clamps to the battery and presents a standard female plug to the male end of the standard extension cord. The extension cord which can be as long as is necessary, presents a female plug to the second portion of the converter which is a standard male plug. The other end of the second portion could be a standard female cigarette lighter connector into which the appliance can be plugged to provide 12 volt current or a structure which provides two clampable elements onto which the battery clamps of some appliances could be connected to provide current to the appliance. Thus, the kit could include the first portion and the first version and/or the second version of the second portion.

### CROSS-REFERENCE TO RELATED APPLICATIONS

This application claims the benefit under 35 U.S.C. §119(e) of U.S. Provisional Application No. 61/444,758 filed Feb. 20, 2011, which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves an system for extending the useful distance between a vehicle battery and battery-powered appliances.

### BACKGROUND OF THE INVENTION

There are many situations in which small 12 volt appliances such as tire pumps can be used around vehicles. In a typical case, these appliances are intended to be plugged into the female cigarette lighter connector on the vehicle. However, there are many situations in which the power cord on the appliance is not long enough to reach from the nearest cigarette lighter connector to the place where the appliance needs to be used. Furthermore, many of these appliances will overload the fuses in the cigarette lighter connector and blow the fuse in the vehicle that supplies the cigarette lighter connector. Because the fuses in many vehicles are not easy to access and because the vehicle does not always carry appropriate spare fuses, this situation can cause serious problems in certain circumstances such as late-night and/or remote vehicle breakdowns.

One way to address this problem would be to connect the appliances power cord directly to the battery, and there are devices available that can be clamped to the battery and which can present a female cigarette lighter connector for use by the appliances male cigarette lighter connector. These devices are generally relatively short and therefore do not typically extend the effective range of the appliance very far. Furthermore, in a circumstance where the distance between the battery and the desired location for use of the appliance is relatively long, the voltage drop in typical small diameter wire would not necessarily properly power the appliance.

These and other difficulties experienced with the prior art devices have been obviated in a novel manner by the present invention.

It is, therefore, an outstanding object of some embodiments of the present invention to provide a system for extending the useful distance between a vehicle battery and battery-powered appliances in an efficient and effective manner.

Another object of some embodiments of the present invention is to provide a system that employs a standard extension cord.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is a system for converting a standard extension cord to an extension cord for vehicle batteries. The first portion of the converter clamps to the vehicle battery and provides a standard female plug to the male end of a standard extension cord. The second portion of the converter plugs into the standard female plug on the standard extension cord and provides, to an appliance, either a cigarette lighter type female connector or a separated pair of clamping elements suitable for accepting battery clamps.

This invention employs a standard 110 volt extension cord and converts the cord for use in the extension of the 12 volt battery power. A first portion of the converter clamps to the battery and presents a standard female plug to the male end of the standard extension cord. The extension cord which can be as long as is necessary, presents a female plug to the second portion of the converter which has a standard male plug at one end. The other end of the second portion could be a standard female cigarette lighter connector into which the appliance can be plugged to provide 12 volt current.

An alternative second portion would have the standard male plug at one end and a structure which provides two clampable elements onto which the battery clamps of some appliances could be connected to provide current to the appliance.

Thus, the kit could include the first portion and either the first version or the second version of the second portion or could include the first portion and both of the versions of the second portion.

### BRIEF DESCRIPTION OF THE DRAWINGS

The character of the invention, however, may best be understood by reference to one of its structural forms, as illustrated by the accompanying drawings, in which:

FIG. 1 is shows a diagram of the general features of one embodiment of the present invention.

FIG. 2 shows an alternative part of the invention.

### DETAILED DESCRIPTION OF THE INVENTION

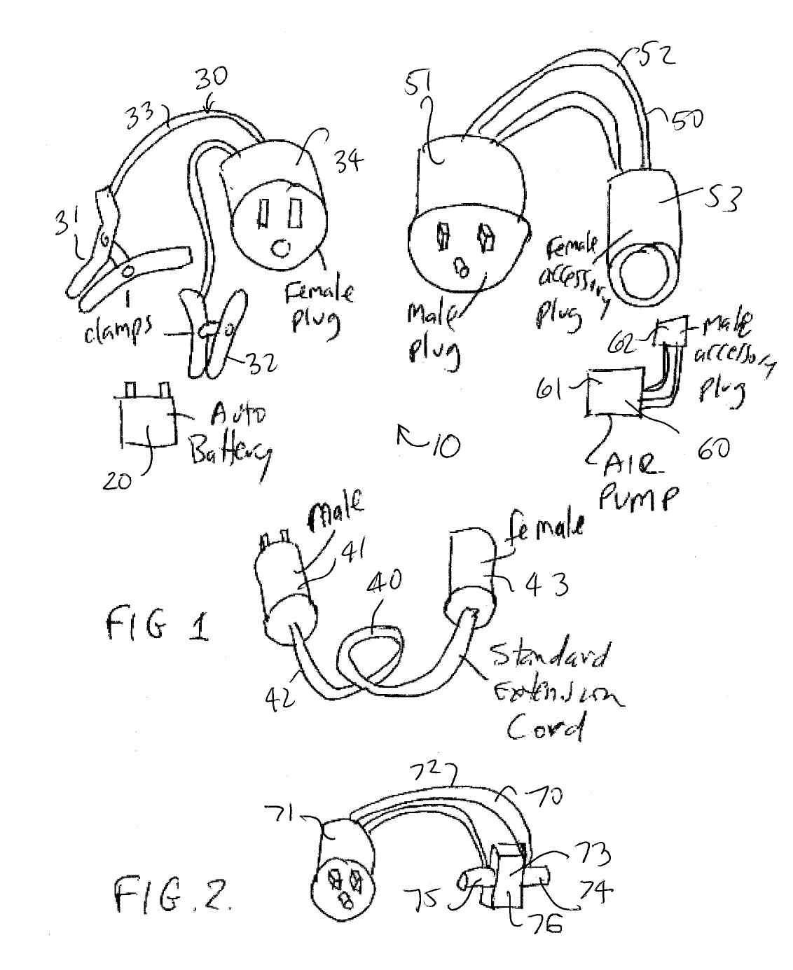

Referring first to FIG. 1 in which the general principles of the present invention are shown, FIG. 1 shows an converter embodying the principles of the present invention, in which the invention 10 employs a standard 110 volt extension cord 40 and converts the cord 40 for use in the extension of 12 volt vehicle battery 20 power. A first portion 30 of the converter 10 clamps to the battery 20 using clamps 31 and 32, through cable 33, and presents a standard female plug 34 to the male end 41 of the standard extension cord 40. The extension cord 40 has a cable 42 which can be as long as is necessary, presents a female plug 43 to the second portion 50 of the converter 10 which has a standard male plug 51 at one end. The other end of the cable 52 of the second portion 50 could be a standard female cigarette lighter connector 53 into which the appliance 60 can be plugged using a standard male auto accessory plug 62 to provide 12 volt current to an appliance 60 such as an air pump 61.

An alternative second portion 70 would have the standard male plug 71 at one end of its cable 72 and a structure 73 which provides two clampable elements 74 and 75, separated by and insulator 76, and onto which the standard battery clamps of some appliances could be connected to provide current to the appliance.

Thus, the kit could include the first portion and either the first version or the second version of the second portion or could include the first portion and both of the versions of the second portion. The kit would be used with a separate standard extension cord

It should be understood that, although the plug gender of the preferred embodiments described above is consistent with conventional electric plug arrangement, with the female plug facing away from the source of power to reduce short circuits, it would be possible to provide the first portion with a male plug instead of a female plug, and the second portion with a female plug instead of a male plug.

The extension cord ends would then just be reversed.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A converter for the extension of DC battery power, comprising:
a. a standard 110 volt extension cord having a male plug at a first end, and a female plug at a second end,
b. a first portion of the converter that has a first end that clamps to the battery and presents a first gender plug at a second end and receives the complementary gender plug of the standard extension cord, and
c. a second portion of the converter which has a second gender plug at a first end that engages the complementary plug end of the standard extension cord, and a second end of the second portion has a connector that can be engaged by a DC appliance to obtain electric power.

2. A converter as recited in claim 1, wherein the connector on the second end of the second portion is a standard female cigarette lighter connector into which the appliance can be plugged to provide 12 volt current.

3. A converter as recited in claim 1, wherein the connector on the second end of the second portion is a connector which includes two clampable elements that can be clamped onto by standard battery clamps on an appliance to provide 12 volt current to the appliance.

4. A converter as recited in claim 1, wherein the connector on the second end of the second portion is a connector which includes two clampable elements that are attached to opposite sides of an electrically insulating element, and that can be clamped onto by standard battery clamps on an appliance to provide 12 volt current to the appliance.

5. A converter as recited in claim 1, wherein the connector on the second end of the first portion is a standard female plug.

6. A converter as recited in claim 1, wherein the connector on the first end of the second portion is a standard male plug.

7. A kit for converting a standard 110 volt extension cord having a male plug at a first end, and a female plug at a second end, for the extension of DC battery power, comprising:
a. a first portion of the converter that has a first end that clamps to the battery and presents a first gender plug at a second end and receives the complementary gender plug of the standard extension cord, and
b. a second portion of the converter which has a second gender plug at a first end that engages the complementary plug end of the standard extension cord, and a second end of the second portion has a connector that can be engaged by a DC appliance to obtain electric power.

8. A kit as recited in claim 7, wherein the connector on the second end of the second portion is a standard female cigarette lighter connector into which the appliance can be plugged to provide 12 volt current.

9. A kit as recited in claim 7, wherein the connector on the second end of the second portion is a connector which includes two clampable elements that can be clamped onto by standard battery clamps on an appliance to provide 12 volt current to the appliance.

10. A kit as recited in claim 7, wherein the connector on the second end of the second portion is a connector which includes two clampable elements that are attached to opposite sides of an electrically insulating element, and that can be clamped onto by standard battery clamps on an appliance to provide 12 volt current to the appliance.

11. A kit as recited in claim 7, wherein the connector on the second end of the first portion is a standard female plug.

12. A kit as recited in claim 7, wherein the connector on the first end of the second portion is a standard male plug.
